(19) United States
(12) Patent Application Publication
(10) Pub. No.: US 2022/0388540 A1
(43) Pub. Date: Dec. 8, 2022

(54) HYBRID DECISION-MAKING METHOD AND DEVICE FOR AUTONOMOUS DRIVING AND COMPUTER STORAGE MEDIUM

(71) Applicant: Xidian University, Xi'an (CN)

(72) Inventors: Yuchuan FU, Xi'an (CN); Changle LI, Xi'an (CN); Pincan ZHAO, Xi'an (CN)

(21) Appl. No.: 17/828,323

(22) Filed: May 31, 2022

(30) Foreign Application Priority Data
May 31, 2021 (CN) 202110606707.7

(51) Int. Cl. B60W 60/00; B60W 50/00; G06N 20/00

(52) U.S. Cl. CPC B60W 60/0015; B60W 50/0098; G06N 20/00; B60W 2050/0028; B60W 2554/4029

(57) ABSTRACT

The present disclosure provides a hybrid decision-making method for autonomous driving, including the following steps: acquiring real-time traffic environment information of an autonomous vehicle during the running at a current moment; establishing a local decision-making model for autonomous driving based on the traffic environment information; based on the local decision-making model for autonomous driving, learning, by using a method based on deep reinforcement learning, a driving behavior of the autonomous vehicle, and extracting driving rules; sharing the driving rules; augmenting an existing expert system knowledge base; and determining whether there is an emergency: if yes, making a decision by using a machine learning model; and if not, adjusting the machine learning model based on the augmented existing expert system knowledge base, and making a decision by the machine learning model. The decision-making method uses two existing policies to complement each other to overcome the shortcomings of a single policy, thereby making decisions effectively for different driving scenarios.

### TECHNICAL FIELD

The present disclosure relates to the technical field of autonomous driving, in particular to a hybrid decision-making method and device for autonomous driving and a computer storage medium.

### BACKGROUND

From a driver assistance system to autonomous driving, this has been a hot topic of extensive research in industry and academia. For the foreseeable future, a connected autonomous vehicle (CAV) will increasingly allow people to choose between driving and being driven, which opens up new scenarios for mobility. In general, autonomous driving requires six basic logic parts, namely, perception, localization and mapping, path planning, decision-making, and vehicle control. A decision-making algorithm will output a decision-making result to a vehicle controller based on sensory data, which will further influence a driving behavior. Therefore, one of main challenges that the decision-making algorithm needs to deal with is how to achieve the high safety and accuracy required for autonomous driving.

At present, in the research and application of decision-making for the CAV, a method based on an expert system (ES) and machine learning has attracted attention. The expert system is based on an independent predefined knowledge base (e.g., maps and traffic rules), allowing input conditions to generate corresponding actions or conclusions (e.g., steering and braking). This type of algorithm is intuitive and easy to reason, understand and apply, and has many successful implementation modes, such as intelligent navigation functions for autonomous driving on expressways, reasoning frameworks for autonomous driving in cities, and fuzzy rule-based mobile navigation control policies. An ES-based decision-making algorithm has strict logical rules, in which a causal relationship between environmental decision-making and behavioral decision-making is very clear, thereby making a decision-making system highly interpretable. However, for an ES-based system, it is often difficult to acquire new knowledge and augment an existing knowledge base. Therefore, its limited knowledge base may not be applicable to new problems, which makes it difficult to achieve high performance of autonomous driving.

### SUMMARY

In view of the above shortcomings in the prior art, an objective of the present disclosure is to provide a hybrid decision-making method for driving in combination with machine learning and an expert system. This decision-making method uses two existing policies to complement each other to overcome the shortcomings of a single policy, thereby making decisions effectively for different driving scenarios.

A hybrid decision-making method for autonomous driving, including the following steps:

acquiring real-time traffic environment information of an autonomous vehicle during the running at a current moment;

establishing a local decision-making model for autonomous driving based on the traffic environment information;

based on the local decision-making model for autonomous driving, learning, by using a method based on deep reinforcement learning, a driving behavior of the autonomous vehicle, and extracting driving rules;

sharing the driving rules;

augmenting an existing expert system knowledge base; and

determining whether there is an emergency: if yes, making a decision by using a machine learning model; and if not, adjusting the machine learning model based on the augmented existing expert system knowledge base, and making a decision by the machine learning model.

Preferably, the local decision-making model for autonomous driving is established based on a Markov decision process model; the Markov decision process model includes: a vehicle model, a pedestrian model, and an obstacle model;

the vehicle model is expressed as: CAV V={v1, v2, . . . , V_{nc}}, wherein nc is the total number of CAVs;

the pedestrian model is expressed as: P={p1, p2, . . . , pₙₚ}, wherein np is the total number of pedestrians; and

the obstacle model is expressed as: O={o1, o2, . . . , oₙₒ}, wherein no is the total number of obstacles.

Preferably, a specific position, a destination, a current state, and a required action in the driving rules are extracted based on IF-THEN rules; and the IF-THEN rules satisfy the following relationship:

If the CAV reaches position P*

And its driving destination is D*

And the state is S*

Then perform action A*

wherein CAV is the autonomous vehicle, P* is the specific position, D* is the destination, S* is the current state, and A* is the required action.

Preferably, the A* includes: an acceleration action and a steering action;

the acceleration action satisfies the following relationship:

Aₐ*={acceleration (aₐ>0)}

∪{constant (aₐ=0)}

∪{deceleration (aₐ<0)}

wherein Aₐ* is the acceleration action, and aₐ is a straight line acceleration; and

the steering action satisfies the following relationship:

Aₛ*: ={turn left (aₛ<0)}

∪{straight (aₛ=0)}

∪{turn right (aₛ>0)}

wherein Aₛ* is the steering action, and aₛ is a steering acceleration.

Preferably, sharing the driving rules includes:

uploading a request message to a node, wherein the request message includes:

$${L \_ Req}_{{CAV}_{j}} \to {MECN}_{i} : {\{ \begin{matrix}{K}_{j}^{pu} \\ h ( {Block}_{t - 1} ) \\ {r}_{j} \\ timestamp\end{matrix} \}}_{{K}_{j}^{pr}}$$

wherein Kⱼ^{pu}, rⱼ and Kⱼ^{pr} are a public key, the driving rules, and a private key of CAVⱼ respectively; and h (Blockₜ₋₁) is a hash of a latest block, and MECNᵢ is a nearby node in a blockchain.

Preferably, augmenting the existing expert system knowledge base includes:

downloading a driving rule set R={r₁, r₂, . . . , rⱼ, . . . , rₘ},(m<nc) to augment the existing expert system knowledge base, wherein the driving rule set satisfies the following relationship:

K=(U,AT=C∪D,V,P)

wherein U is an entire object; AT is a set of limited non-null attributes, divided into two parts, wherein C is a set of conditional attributes, including position attributes and state attributes, and D is a set of decision attributes; V is a range of attributes; and P is an information function.

Preferably, determining whether there is the emergency includes: determining whether there is the emergency by using a subjective safety distance model, wherein

the subjective safety distance model satisfies the following relationship:

$$\{ \begin{matrix}{S}_{h} ( t ) > {S}_{bp} + {s}_{fd} - {x}_{L T} , Normal \\ {S}_{h} ( t ) \leq {S}_{bp} + {s}_{fd} - {x}_{L T} , Emergency\end{matrix}$$

wherein Sₕ(t) represents a space headway of the vehicle and a main traffic participant; S_{bp} represents a braking distance of OV; x_{LT} represents a longitudinal displacement of the main traffic participant; and s_{fd} represents a final following distance.

Preferably, adjusting the machine learning model based on the augmented existing expert system knowledge base includes:

combining the augmented existing expert system knowledge base with the current local decision-making model for autonomous driving to generate an overall action space, wherein the overall action space includes: the acceleration action, a deceleration action and a steering action.

Provided is a hybrid decision-making device for autonomous driving, including:

a memory, configured to store computer programs; and

a central processing unit, configured to implement the steps of the hybrid decision-making method for autonomous driving when executing the computer programs.

Provided is a computer-readable storage medium, wherein the computer programs are stored in the computer-readable storage medium, and cause the central processing unit to implement the steps of the hybrid decision-making method for autonomous driving when being executed by the central processing unit.

The hybrid decision-making method for autonomous driving provided by the present disclosure includes the following steps: acquiring the real-time traffic environment information of the autonomous vehicle during the running at the current moment; establishing the local decision-making model for autonomous driving based on the traffic environment information; based on the local decision-making model for autonomous driving, learning, by using the method based on deep reinforcement learning, the driving behavior of the autonomous vehicle, and extracting the driving rules; sharing the driving rules; augmenting the existing expert system knowledge base; and determining whether there is the emergency: if yes, making the decision by using the machine learning model; and if not, adjusting the machine learning model based on the augmented existing expert system knowledge base, and making the decision by the machine learning model. This decision-making method uses the two existing policies to complement each other to overcome the shortcomings of the single policy, thereby making the decisions effectively for the different driving scenarios.

### BRIEF DESCRIPTION OF DRAWINGS

To more clearly illustrate the embodiments of the present application or the technical solution in the prior art, the accompanying drawings that need to be used in the description of the embodiments or the prior art will be simply introduced below. Apparently, the accompanying drawings in the description below are merely the embodiments of the present application. Those of ordinary skill in the art may also obtain other accompanying drawings according to the provided accompanying drawings without creative efforts.

FIG. 1 is a flowchart of a hybrid decision-making method for autonomous driving provided by an embodiment of the present application.

FIG. 2 is a schematic structural diagram of a hybrid decision-making device for autonomous driving provided by an embodiment of the present application.

FIG. 3 is another schematic structural diagram of the hybrid decision-making device for autonomous driving provided by the embodiment of the present application.

### DETAILED DESCRIPTION OF EMBODIMENTS

The technical solution in the embodiments of the present application will be clearly and completely described below with reference to the accompanying drawings in the embodiments of the present application. Apparently, the described embodiments are merely a part, rather than all of the embodiments of the present application. All other embodiments obtained by those of ordinary skill in the art based on the embodiments in the present application without creative efforts shall fall within the scope of protection of the present application.

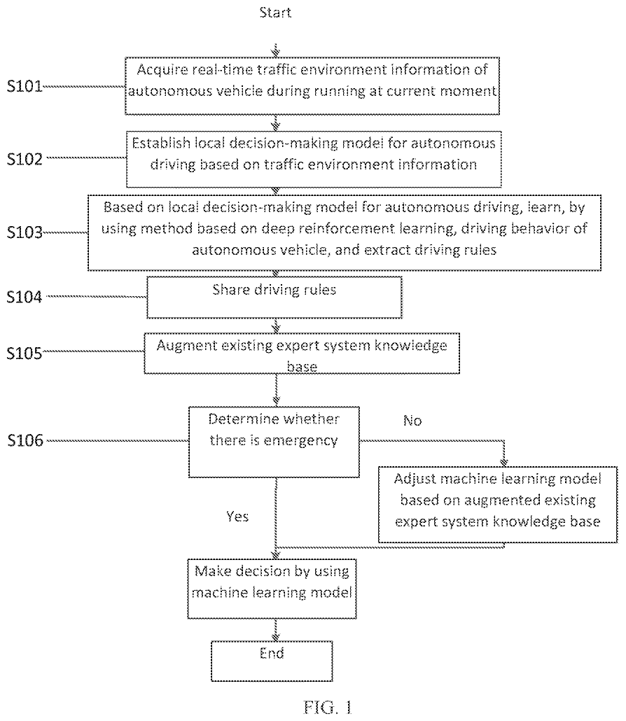

Referring to FIG. 1, FIG. 1 is a flowchart of a hybrid decision-making method for autonomous driving provided by an embodiment of the present application.

An embodiment of the present application provides a hybrid decision-making method for autonomous driving, which may include the following steps:

Step S101: real-time traffic environment information of an autonomous vehicle during the running at a current moment is acquired.

In practical applications, during the autonomous driving, it is necessary to predict a next driving action of the autonomous vehicle according to the current traffic environment information, so the real-time traffic environment information of the autonomous vehicle during the running at the current moment may be acquired first. The type of the real-time traffic environment information may be determined according to actual needs. For example, vehicle-mounted sensor devices such as cameras, global positioning systems, inertial measurement units, millimeter-wave radars, and lidars may be used to acquire driving environment states, such as weather data, traffic lights and traffic topology information, and position and running state information of autonomous vehicles and other traffic participants. Raw traffic environment information such as direct raw image data acquired by the cameras may be used directly as the real-time traffic environment information, and a depth map and a semantic segmentation map obtained by processing the raw traffic environment information through models such as RefineNet may also be used as the real-time traffic environment information.

Step S102: a local decision-making model for autonomous driving is established based on the traffic environment information.

In specific application scenarios, the local decision-making model for autonomous driving is established based on a Markov decision process model; the Markov decision process model includes: a vehicle model, a pedestrian model, and an obstacle model;

the vehicle model is expressed as: CAV V={v1, v2, . . . , V_{nc}}, wherein nc is the total number of CAVs;

the pedestrian model is expressed as: P={p1, p2, . . . , pₙₚ}, wherein np is the total number of pedestrians; and

the obstacle model is expressed as: O={o1, o2, . . . , oₙₒ}, wherein no is the total number of obstacles.

Step S103: based on the local decision-making model for autonomous driving, a driving behavior of the autonomous vehicle is learnt by using a method based on deep reinforcement learning, and driving rules are extracted.

In practical applications, traffic scenarios that a single vehicle may involve are limited, and correct decisions may not be made when new situations are encountered. For an ES-based system, there is a bottleneck in knowledge acquisition, so it is often difficult to augment an existing knowledge base. For a machine learning-based method, there are limitations of training data and the shortcomings of the opaque method. Therefore, it is difficult to achieve high performance of autonomous driving with its limited knowledge base for the constantly changing traffic scenarios. To sum up, in order to improve the environmental adaptability of the knowledge base of the autonomous vehicle, a knowledge base expansion policy needs to be designed. This policy uses multiple CAVs, and augments the knowledge base of each CAV through the steps of driving rule extraction, rule sharing, and knowledge base augmentation.

The driving behavior of the CAV may be learnt by using the method based on deep reinforcement learning, and is used as a basis for driving rule extraction and sharing. Therefore, next, an action space, a state space and a reward function are improved respectively.

1) The action space: during the running, each CAV (including an objective vehicle OV) mainly controls an acceleration and a steering angle of the vehicle, so as to achieve safe and correct driving along a given route. Therefore, the action space a(t) at the time t includes the acceleration aₐ(t) and the steering angle aₛ(t), and may be expressed as:

a(t)={aₐ(t),aₛ(t)}

In view of the driving comfort, the acceleration is in a range of [−4, 2] m/s². In addition, the CAV performs steering operation by selecting the steering angle in a range of [−40°, 40°], which is related to a vehicle's minimum turning radius, a vehicle's wheelbase, and a tire's offset.

2) The state space: for all the traffic participants in a scenario, their states at the time t may be expressed by a velocity V(t), a position P(t), and a driving direction α(t). For the obstacles (such as roadblocks and road accidents), their states at the time t may be expressed by a position Po(t) and a size (i.e., length 1 and width w) due to fixed positions. Therefore, the state space may be expressed as:

s(t)={sₒᵥ(t),sᵥᵢ(t),sₚⱼ(t),sₒₖ(t)}

wherein sₒᵥ(t), sᵥᵢ(t), sₚⱼ(t), and sₒₖ(t) represent a state of the OV, the other CAVs, the pedestrians, and the obstacles; and parameters i, j, and k represent an ith CAV, a jth pedestrian, and a kth obstacle in the traffic scenario respectively. Specifically, each state at the time t may be decomposed into:

$$\{ \begin{matrix}{s}_{OV} ( t ) = \{ {V}_{OV} ( t ) , & {P}_{OV} ( t ) , {θ}_{OV} ( t ) \} \\ {s}_{vi} ( t ) = \{ {V}_{vi} ( t ) , & {P}_{vi} ( t ) , {θ}_{vi} ( t ) \} \\ {s}_{pj} ( t ) = \{ {V}_{pj} ( t ) , & {P}_{pj} ( t ) , {θ}_{pj} ( t ) \} \\ {s}_{ok} ( t ) = \{ {P}_{ok} ( t ) , & {1}_{ok} ( t ) , {w}_{ok} ( t ) \}\end{matrix}$$

in view of the interactions between the traffic participants, under the condition that a current state s(t) and a selected action a(t) are given, a transition probability may be expressed as:

P(s(t+1)|s(t),a(t))=P(s_{OV}(t+1)|s_{OV}(t),a(t))

P(sᵥᵢ(t+1)|s(t))

P(sₚⱼ(t+1)|s(t))

The action selection of the OV is mainly based on the designed reward function. For the other CAVs and the pedestrians, it is necessary to follow basic traffic rules (e.g., the CAVs need to yield to the pedestrians) and determine whether behaviors are safe. Therefore, the behaviors of the other CAVs and the pedestrians depend on their respective states and environmental states. The transition probability may be obtained by dynamic functions of the CAVs and the pedestrians, and state variables may be obtained by a sensing system.

3) The reward function: in reinforcement learning, a task-specific reward function that guides the CAV in learning is an important part. In order to simplify a learning process, a relatively simple reward function is designed based on daily driving behaviors to reward or punish the CAV in driving. The reward function includes the following parts, namely, the correctness of the driving direction, the safety of driving, and the necessity of lane changing.

According to traffic laws, the driving direction of the vehicle must be in the same direction as a road. Otherwise, the retrograde CAV will be penalized.

r₁(t)=cos α(t)−sin α(t)

wherein α>0 represents an angle between the driving direction of the vehicle and the direction of the road.

Driving safety is very important, so if an accident occurs while driving, the CAV will be penalized. In particular, if the accident is caused while driving, this event will end.

r₂(t)=−(v(t)²+δ)□{Collsion}

where δ>0 is a weight. A term {Collsion} represents that a value is 1 if a collision occurs, otherwise, is 0. In addition, the higher the driving velocity is, the more serious the accident will be.

Under normal circumstances, frequent lane changing will affect traffic efficiency and even lead to traffic accidents. Therefore, changing lanes unnecessarily is not advocated. In view of the adverse effects of frequent lane changing during the driving, when there is no vehicle within x meters ahead and people may drive to the destination by the current road, a lane changing behavior will be penalized:

$${r}_{3} ( t ) = \{ \begin{matrix}- ( {S}_{h} ( t ) - x ) , if current = d e s t \\ 0 , if current \neq dest or {S}_{h} ( t ) \leq x\end{matrix}$$

wherein Sh(t) represents a space where a preceding vehicle is driving in the same lane.

The final reward function is a weighted sum of three reward functions, and may be expressed as:

$${r}_{3} ( t ) = {\sum }_{i = 1}^{3} {w}_{i} {r}_{i} ( t )$$

wherein wᵢ is a weight.

In specific application scenarios, a specific position, a destination, a current state, and a required action in the driving rules are extracted based on IF-THEN rules; and the IF-THEN rules satisfy the following relationship:

If the CAV reaches position P*

And its driving destination is D*

And the state is S*

Then perform action A*

wherein CAV is the autonomous vehicle, P* is the specific position, D* is the destination, S* is the current state, and A* is the required action.

In specific application scenarios, A* includes: an acceleration action and a steering action;

the acceleration action satisfies the following relationship:

Aₐ*={acceleration (aₐ>0)}

∪{constant (aₐ=0)}

∪{deceleration (aₐ<0)}

wherein Aₐ* is a the acceleration action, and aₐ is a straight line acceleration; and

the steering action satisfies the following relationship:

Aₛ*={turn left (aₛ<0)}

∪{straight (aₛ=0)}

∪{turn right (aₛ>0)}

wherein Aₛ* is the steering action, and aₛ is a steering acceleration.

Step S104: the driving rules are shared.

In practical applications, after the driving rules are extracted, the corresponding CAV will upload the driving rules to a nearby mobile edge computing node (MECN) for sharing. During the rule sharing, the CAV may provide incorrect information or be attacked for various reasons, and the MECN may not be fully trusted. In order to solve the problems of user privacy and data security during the rule sharing, a blockchain network is adopted.

In specific application scenarios, sharing the driving rules includes:

a request message is uploaded to a node, wherein the request message includes:

$${L}_{-} {Req}_{{CAV}_{j}} \to M E C {N}_{i} : {\{ \begin{matrix}{K}_{j}^{p u} \\ h ( {Block}_{t - 1} ) \\ {r}_{j} \\ time s t a m p\end{matrix} \}}_{{K}_{j}^{pr}}$$

wherein Kⱼ^{pu}, rⱼ and Kⱼ^{pr} are a public key, the driving rules, and a private key of CAVⱼ respectively; and h(Blockₜ₋₁) is a hash of a latest block, and MECNᵢ is a nearby node in a blockchain.

MECNᵢ adds the uploaded driving rules to a new message, wherein the new message is as follows:

$${L}_{-} {Res}_{{MECN}_{i}} \to C A {V}_{j} : {\{ \begin{matrix}{L\_Req}_{{CAV}_{j}} \to {MECN}_{i} \\ {K}_{i}^{p u} \\ {r}_{j} \\ timestamp\end{matrix} \}}_{{K}_{i}^{p r}}$$

a public key and a private key of MECNᵢ are Kᵢ^{pu} and Kᵢ^{pr} respectively. Then, in order to verify its validity, the MECN broadcasts a record to other MECNs acting as verification nodes. During a certain period, the producer packs aggregate records from all CAVs into a block. This block will be added to the end of the blockchain after a consensus is reached using a delegated proof of stake (BFT-DPoS) consensus algorithm with Byzantine fault tolerance.

Step S105: an existing expert system knowledge base is augmented.

In specific application scenarios, augmenting the existing expert system knowledge base includes:

a driving rule set R={r₁, r₂, . . . , rⱼ, . . . , rₘ},(m<nc) is downloaded to augment the existing expert system knowledge base, wherein the driving rule set satisfies the following relationship:

K=(U,AT=C∪D,V,P)

wherein U is an entire object; AT is a set of limited non-null attributes, divided into two parts, wherein C is a set of conditional attributes, including position attributes and state attributes, and D is a set of decision attributes; V is a range of attributes; and P is an information function.

When the knowledge base is augmented, the extracted driving rules are tested according to the following way:

Redundancy testing: the driving rules with the same conclusion and different attributes are combined.

Disagreement testing: for the driving rules with the same attributes and different conclusions, the selection of the driving rules and the update of the decision-making model are both based on the conclusions of most current CAVs, so the correct conclusions are retained.

Completeness testing: the decision-making model is extended only by the complete driving rules, i.e., the driving rules have conditions and conclusions. As a result, the rules that lack C or D are deleted.

After the above driving rules are extracted and tested, each driving rule is added into the decision-making model, so as to realize the whole process of learning the driving rules.

Step S106: whether there is an emergency is determined: if yes, a decision is made by using a machine learning model; and if not, the machine learning model is adjusted based on the augmented existing expert system knowledge base, and a decision is made by the machine learning model.

In specific application scenarios, whether there is the emergency is determined based on a subjective safety distance model; and

the subjective safety distance model satisfies the following relationship:

$$\{ \begin{matrix}{S}_{h} ( t ) > {S}_{bp} + {s}_{fd} - {x}_{L T} , Normal \\ {S}_{h} ( t ) \leq {S}_{bp} + {s}_{fd} - {x}_{L T} , Emergency\end{matrix}$$

wherein Sₕ(t) represents a space headway of the vehicle and a main traffic participant; S_{bp} represents a braking distance of the OV; x_{LT} represents a longitudinal displacement of the main traffic participant; and s_{fd} represents a final following distance.

In specific application scenarios, adjusting the machine learning model based on the augmented existing expert system knowledge base includes:

the augmented existing expert system knowledge base is combined with the current local decision-making model for autonomous driving to generate an overall action space, wherein the overall action space includes: the acceleration action, a deceleration action and a steering action.

The CAV (referring to the OV) reaches a certain position P*, the downloaded latest driving rule set is used and an augmented existing decision-making model is combined with the current local decision-making model for autonomous driving to generate the overall action space A*, including whether to accelerate/decelerate and whether to make a turn. It is assumed that ac(t) is the currently selected action, there are two cases as follows:

If ac(t) is in A*, then a driving policy of the OV (a DQN agent) is basically the same as a driving policy of the existing decision-making model. The selected action may be updated according to the following formula:

a(t)=wa^{c}(t)+(1−w)A*

If a^{c}(t) is not in A*, the driving policy of the OV (the DQN agent) is inconsistent with the driving policy of the existing decision-making model. There are two main reasons for such cases. On the one hand, it may be that the performance of the OV is insufficient or navigation information is not updated, causing the agent to choose inappropriate operation. On the other hand, the road environment may change, for example, temporary roadblocks are removed, and the existing decision-making model has not been updated. In this case, it is necessary to determine the reason.

For the first case, the operation is selected according to the existing decision-making model. For the second case, the OV needs to make its own decisions based on the traffic environment.

The hybrid decision-making method for autonomous driving provided by the present disclosure includes the following steps: the real-time traffic environment information of the autonomous vehicle during the running at the current moment is acquired; the local decision-making model for autonomous driving is established based on the traffic environment information; based on the local decision-making model for autonomous driving, the driving behavior of the autonomous vehicle is learnt by using the method based on deep reinforcement learning, and the driving rules are extracted; the driving rules are shared; the existing expert system knowledge base is augmented; and whether there is the emergency is determined: if yes, the decision is made by using the machine learning model; and if not, the machine learning model is adjusted based on the augmented existing expert system knowledge base, and the decision is made by the machine learning model. The decision-making method uses two existing policies to complement each other to overcome the shortcomings of a single policy, thereby making decisions effectively for different driving scenarios. Meanwhile, the sharing of the rules by using the blockchain network may prevent the situation that the CAV may provide incorrect information or be attacked for various reasons, and the MECN may not be fully trusted.

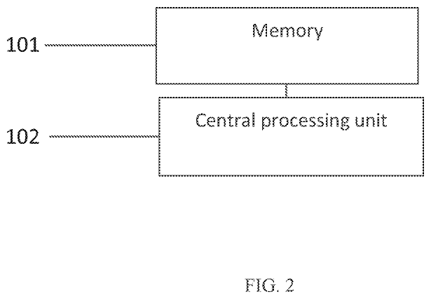

Referring to FIG. 2, an embodiment of the present application provides a hybrid decision-making device for autonomous driving. The hybrid decision-making device includes a memory 101 and a central processing unit 102; computer programs are stored in the memory 101; and the central processing unit 102 implements the following steps when executing the computer programs:

real-time traffic environment information of an autonomous vehicle during the running at a current moment is acquired;

a local decision-making model for autonomous driving is established based on the traffic environment information;

based on the local decision-making model for autonomous driving, a driving behavior of the autonomous vehicle is learnt by using a method based on deep reinforcement learning, and driving rules are extracted;

the driving rules are shared;

an existing expert system knowledge base is augmented; and

whether there is an emergency is determined: if yes, a decision is made by using a machine learning model; and if not, the machine learning model is adjusted based on the augmented existing expert system knowledge base, and a decision is made by the machine learning model.

The hybrid decision-making device for autonomous driving provided by the embodiment of the present application includes the memory 101 and the central processing unit 102; the computer programs are stored in the memory 101; and the central processing unit 102 implements the following steps when executing the computer programs:

the local decision-making model for autonomous driving is established based on a Markov decision process model; the Markov decision process model includes: a vehicle model, a pedestrian model, and an obstacle model;

the vehicle model is expressed as: CAV V={v1, v2, . . . , V_{nc}}, wherein nc is the total number of CAVs;

the pedestrian model is expressed as: P={p1, p2, . . . , pₙₚ}, wherein np is the total number of pedestrians; and

the obstacle model is expressed as: O={o1, o2, . . . , oₙₒ}, wherein no is the total number of obstacles.

The hybrid decision-making device for autonomous driving provided by the embodiment of the present application includes the memory 101 and the central processing unit 102; the computer programs are stored in the memory 101; and the central processing unit 102 implements the following steps when executing the computer programs:

a specific position, a destination, a current state, and a required action in the driving rules are extracted based on IF-THEN rules; and the IF-THEN rules satisfy the following relationship:

If the CAV reaches position P*

And its driving destination is D*

And the state is S*

Then perform action A*

wherein CAV is the autonomous vehicle, P* is the specific position, D* is the destination, S* is the current state, and A* is the required action.

A* includes: an acceleration action and a steering action;

the acceleration action satisfies the following relationship:

Aₐ*={acceleration (aₐ>0)}

∪{constant (aₐ=0)}

∪{deceleration (aₐ<0)}

wherein Aₐ* is the acceleration action, and aₐ is a straight line acceleration; and

the steering action satisfies the following relationship:

Aₛ*={turn left (aₛ<0)}

∪{straight (aₛ=0)}

∪{turn right (aₛ>0)}
Aₛ*: is the steering action, and aₛ is a steering acceleration.

The hybrid decision-making device for autonomous driving provided by the embodiment of the present application includes the memory 101 and the central processing unit 102; the computer programs are stored in the memory 101; and the central processing unit 102 implements the following steps when executing the computer programs:

a request message is uploaded to a node, wherein the request message includes:

$${L}_{-} {Req}_{{CAV}_{j}} \to M E C {N}_{i} : {\{ \begin{matrix}{K}_{j}^{p u} \\ h ( {Block}_{t - 1} ) \\ {r}_{j} \\ time s t a m p\end{matrix} \}}_{{K}_{j}^{pr}}$$

wherein Kⱼ^{pu}, rⱼ and Kⱼ^{pr} are a public key, the driving rules, and a private key of CAVⱼ respectively; and h(Blockₜ₋₁) is a hash of a latest block, and MECNᵢ is a nearby node in a blockchain.

The hybrid decision-making device for autonomous driving provided by the embodiment of the present application includes the memory 101 and the central processing unit 102; the computer programs are stored in the memory 101; and the central processing unit 102 implements the following steps when executing the computer programs:

a driving rule set R={r₁, r₂, . . . , rⱼ, . . . , rₘ},(m<nc) is downloaded to augment the existing expert system knowledge base, wherein the driving rule set satisfies the following relationship:

K=(U,AT=C∪D,V,P)

wherein U is an entire object; AT is a set of limited non-null attributes, divided into two parts, wherein C is a set of conditional attributes, including position attributes and state attributes, and D is a set of decision attributes; V is a range of attributes; and P is an information function.

The hybrid decision-making device for autonomous driving provided by the embodiment of the present application includes the memory 101 and the central processing unit 102; the computer programs are stored in the memory 101; and the central processing unit 102 implements the following steps when executing the computer programs:

whether there is the emergency is determined based on a subjective safety distance model; and

the subjective safety distance model satisfies the following relationship:

$$\{ \begin{matrix}{S}_{h} ( t ) > {S}_{b p} + {s}_{fd} - {x}_{L T} , Normal \\ {S}_{h} ( t ) \leq {S}_{b p} + {s}_{fd} - {x}_{L T} , Emergency\end{matrix}$$

wherein Sₕ(t) represents a space headway of the vehicle and a main traffic participant; S_{bp} represents a braking distance of OV; x_{LT} represents a longitudinal displacement of the main traffic participant; and s_{fd} represents a final following distance.

The hybrid decision-making device for autonomous driving provided by the embodiment of the present application includes the memory 101 and the central processing unit 102; the computer programs are stored in the memory 101; and the central processing unit 102 implements the following steps when executing the computer programs:

the augmented existing expert system knowledge base is combined with the current local decision-making model for autonomous driving to generate an overall action space, wherein the overall action space includes: the acceleration action, a deceleration action and a steering action.

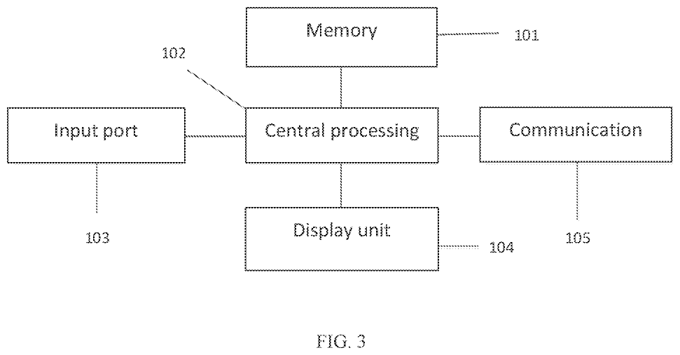

Referring to FIG. 3, another hybrid decision-making device for autonomous driving provided by an embodiment of the present application further includes: an input port 103 connected with the central processing unit 102 and configured to transmit commands input from the outside to the central processing unit 102; a display unit 104 connected with the central processing unit 102 and configured to display a processing result of the central processing unit 102 to the outside; and a communication module 105 connected with the central processing unit 102 and configured to realize the communication between the autonomous driving device and the outside. The display unit 104 may be a display panel, a laser scanning display, etc.; a communication mode adopted by the communication module 105 includes, but is not limited to, a mobile high-definition link (HML), a universal serial bus (USB), a high-definition multimedia interface (HDMI), a wireless connection: wireless fidelity (WiFi), a Bluetooth communication technology, a low-power Bluetooth communication technology, and a IEEE802.11s-based communication technology.

An embodiment of the present application provides a computer-readable storage medium. Computer programs are stored in the computer-readable storage medium, and cause a central processing unit to implement the following steps when being executed by the central processing unit:

real-time traffic environment information of an autonomous vehicle during the running at a current moment is acquired;

a local decision-making model for autonomous driving is established based on the traffic environment information;

based on the local decision-making model for autonomous driving, a driving behavior of the autonomous vehicle is learnt by using a method based on deep reinforcement learning, and driving rules are extracted;

the driving rules are shared;

an existing expert system knowledge base is augmented; and

whether there is an emergency is determined: if yes, a decision is made by using a machine learning model; and if not, the machine learning model is adjusted based on the augmented existing expert system knowledge base, and a decision is made by the machine learning model.

According to the computer-readable storage medium provided by the embodiment of the present application, the computer programs are stored in the computer-readable storage medium, and cause the central processing unit to implement the following steps when being executed by the central processing unit:

the local decision-making model for autonomous driving is established based on a Markov decision process model; the Markov decision process model includes: a vehicle model, a pedestrian model, and an obstacle model;

the vehicle model is expressed as: CAV V={v1, v2, . . . , V_{nc}}, wherein nc is the total number of CAVs;

the pedestrian model is expressed as: P={p1, p2, . . . , pₙₚ}, wherein np is the total number of pedestrians; and

the obstacle model is expressed as: O={o1, o2, . . . , oₙₒ}, wherein no is the total number of obstacles.

According to the computer-readable storage medium provided by the embodiment of the present application, the computer programs are stored in the computer-readable storage medium, and cause the central processing unit to implement the following steps when being executed by the central processing unit:

a specific position, a destination, a current state, and a required action in the driving rules are extracted based on IF-THEN rules; and the IF-THEN rules satisfy the following relationship:

If the CAV reaches position P*

And its driving destination is D*

And the state is S*

Then perform action A*

wherein CAV is the autonomous vehicle, P* is the specific position, D* is the destination, S* is the current state, and A* is the required action.

A* includes: an acceleration action and a steering action;

the acceleration action satisfies the following relationship:

Aₐ*={acceleration (aₐ>0)}

∪{constant (aₐ=0)}

∪{deceleration (aₐ<0)}

wherein Aₐ* is the acceleration action, and aₐ is a straight line acceleration; and

the steering action satisfies the following relationship:

Aₛ*={turn left (aₛ<0)}

∪{straight (aₛ=0)}

∪{turn right (aₛ>0)}
Aₛ* is the steering action, and aₛ is s a steering acceleration.

According to the computer-readable storage medium provided by the embodiment of the present application, the computer programs are stored in the computer-readable storage medium, and cause the central processing unit to implement the following steps when being executed by the central processing unit:

a request message is uploaded to a node, wherein the request message includes:

$${L}_{-} {Req}_{{CAV}_{j}} \to M E C {N}_{i} : {\{ \begin{matrix}{K}_{j}^{p u} \\ h ( {Block}_{t - 1} ) \\ {r}_{j} \\ time s t a m p\end{matrix} \}}_{{K}_{j}^{pr}}$$

wherein, Kⱼ^{pu}, rⱼ and Kⱼ^{pr} are a public key, the driving rules, and a private key of CAVⱼ respectively; and h(Blockₜ₋₁) is a hash of a latest block, and MECNᵢ is a nearby node in a blockchain.

According to the computer-readable storage medium provided by the embodiment of the present application, the computer programs are stored in the computer-readable storage medium, and cause the central processing unit to implement the following steps when being executed by the central processing unit:

a driving rule set R={r₁, r₂, . . . , rⱼ, . . . , rₘ},(m<nc) is downloaded to augment the existing expert system knowledge base, wherein the driving rule set satisfies the following relationship:

K=(U,AT=C∪D,V,P)

wherein U is an entire object; AT is a set of limited non-null attributes, divided into two parts, wherein C is a set of conditional attributes, including position attributes and state attributes, and D is a set of decision attributes; V is a range of attributes; and P is an information function.

According to the computer-readable storage medium provided by the embodiment of the present application, the computer programs are stored in the computer-readable storage medium, and cause the central processing unit to implement the following steps when being executed by the central processing unit:

whether there is the emergency is determined based on a subjective safety distance model; and

the subjective safety distance model satisfies the following relationship:

$$\{ \begin{matrix}{S}_{h} ( t ) > {S}_{bp} + {s}_{fd} - {x}_{L T} , Normal \\ {S}_{h} ( t ) \leq {S}_{bp} + {s}_{fd} - {x}_{L T} , Emergency\end{matrix}$$

wherein Sₕ(t) represents a space headway of the vehicle and a main traffic participant; S_{bp} represents a braking distance of an OV; x_{LT} represents a longitudinal displacement of the main traffic participant; and s_{fd} represents a final following distance.

According to the computer-readable storage medium provided by the embodiment of the present application, the computer programs are stored in the computer-readable storage medium, and cause the central processing unit to implement the following steps when being executed by the central processing unit:

the augmented existing expert system knowledge base is combined with the current local decision-making model for autonomous driving to generate an overall action space, wherein the overall action space includes: the acceleration action, a deceleration action and a steering action.

The computer-readable storage medium involved in the present application includes a random access memory (RAM), a memory, a read-only memory (ROM), an electrically programmable ROM, an electrically erasable and programmable ROM, a register, a hard disk, a removable disk, a compact disc read-only memory (CD-ROM), or any other form of storage medium known in the technical field.

The description of the relevant parts in the hybrid decision-making device for autonomous driving and the computer-readable storage medium provided by the embodiments of the present application refers to the detailed description of the corresponding parts in the hybrid decision-making method for autonomous driving provided by the embodiment of the present application, which will not be repeated herein. In addition, the parts, in the above technical solution provided by the embodiments of the present application, with the same implementation principle as the corresponding technical solution in the prior art are not described in detail, so as to avoid redundant descriptions.

It should also be noted that in this document, relational terms such as first and second are merely used to distinguish one entity or operation from another, and do not necessarily require or imply that there is any such actual relationship or sequence among these entities or operations. Furthermore, a term “include”, “contain”, or any other variation thereof is intended to cover non-exclusive inclusion, so that a process, method, article, or device including a series of elements includes not only those elements, but other elements that are not explicitly listed or elements inherent to such process, method, article, or device. Without more limitations, an element limited by a statement “includes a . . . ” does not preclude the presence of additional identical elements in the process, method, article, or device including the elements.

The above description of the disclosed embodiments enables those skilled in the art to be able to implement or use the present application. Various modifications to these embodiments will be readily apparent to those skilled in the art, and generic principles defined herein may be implemented in other embodiments without departing from the spirit or scope of the present application. Therefore, the present application will not be limited to these embodiments shown herein, but will conform to the widest scope consistent with the principles and novel features disclosed herein.

1. A hybrid decision-making method for autonomous driving, comprising the following steps:
acquiring real-time traffic environment information of an autonomous vehicle during the running at a current moment;
establishing a local decision-making model for autonomous driving based on the traffic environment information;
based on the local decision-making model for autonomous driving, learning, by using a method based on deep reinforcement learning, a driving behavior of the autonomous vehicle, and extracting driving rules;
sharing the driving rules;
augmenting an existing expert system knowledge base; and
determining whether there is an emergency: if yes, making a decision by using a machine learning model; and if not, adjusting the machine learning model based on the augmented existing expert system knowledge base, and making a decision by the machine learning model.

2. The hybrid decision-making method for autonomous driving according to claim 1, wherein the local decision-making model for autonomous driving is established based on a Markov decision process model; the Markov decision process model comprises: a vehicle model, a pedestrian model, and an obstacle model;
the vehicle model is expressed as: CAV V={v1, v2, . . . , V_{nc}}, wherein nc is the total number of CAVs;
the pedestrian model is expressed as: P={p1, p2, . . . , pₙₚ}, wherein np is the total number of pedestrians; and
the obstacle model is expressed as: O={o1, o2, . . . , oₙₒ}, wherein no is the total number of obstacles.

3. The hybrid decision-making method for autonomous driving according to claim 1, wherein a specific position, a destination, a current state, and a required action in the driving rules are extracted based on IF-THEN rules; and the IF-THEN rules satisfy the following relationship:
If the CAV reaches position P*
And its driving destination is D*
And the state is S*
Then perform action A*
wherein CAV is the autonomous vehicle, P* is the specific position, D* is the destination, S* is the current state, and A* is the required action.

4. The hybrid decision-making method for autonomous driving according to claim 3, wherein the A* comprises: an acceleration action and a steering action;
the acceleration action satisfies the following relationship:
Aₐ*={acceleration (aₐ>0)}
∪{constant (aₐ=0)}
∪{deceleration (aₐ<0)}
wherein Aₐ* is the acceleration action, and aₐ is a straight line acceleration; and
the steering action satisfies the following relationship:
A: ={turn left (aₛ<0)}
∪{straight (aₛ=0)}
∪{turn right (aₛ>0)}
Aₛ* is the steering action, and aₛ a steering acceleration.

5. The hybrid decision-making method for autonomous driving according to claim 1, wherein sharing the driving rules comprises:
uploading a request message to a node, wherein the request message comprises:
$${L}_{-} {Req}_{{CAV}_{j}} \to M E C {N}_{i} : {\{ \begin{matrix}{K}_{j}^{p u} \\ h ( {Block}_{t - 1} ) \\ {r}_{j} \\ time s t a m p\end{matrix} \}}_{{K}_{j}^{pr}}$$
wherein Kⱼ^{pu}, rⱼ and Kⱼ^{pr} are a public key, the driving rules, and a private key of CAVⱼ respectively; and h(Blockₜ₋₁) is a hash of a latest block, and MECNᵢ is a nearby node in a blockchain.

6. The hybrid decision-making method for autonomous driving according to claim 1, wherein augmenting the existing expert system knowledge base comprises:
downloading a driving rule set R={r₁, r₂, . . . , rⱼ, . . . , rₘ},(m<nc) to augment the existing expert system knowledge base, wherein the driving rule set satisfies the following relationship:
K=(U,AT=C∪D,V,P)
wherein U is an entire object; AT is a set of limited non-null attributes, divided into two parts, wherein C is a set of conditional attributes, comprising position attributes and state attributes, and D is a set of decision attributes; V is a range of attributes; and P is an information function.

7. The hybrid decision-making method for autonomous driving according to claim 1, wherein whether there is the emergency is determined based on a subjective safety distance model; and
the subjective safety distance model satisfies the following relationship:
$$\{ \begin{matrix}{S}_{h} ( t ) > {S}_{bp} + {s}_{fd} - {x}_{L T} , Normal \\ {S}_{h} ( t ) \leq {S}_{bp} + {s}_{fd} - {x}_{L T} , Emergency\end{matrix}$$
wherein Sₕ(t) represents a space headway of the vehicle and a main traffic participant; S_{bp} represents a braking distance of OV; x_{LT} represents a longitudinal displacement of the main traffic participant; and s_{fd} represents a final following distance.

8. The hybrid decision-making method for autonomous driving according to claim 1, wherein adjusting the machine learning model based on the augmented existing expert system knowledge base comprises:
combining the augmented existing expert system knowledge base with the current local decision-making model for autonomous driving to generate an overall action space, wherein the overall action space comprises: an acceleration action, a deceleration action and a steering action.

9. A hybrid decision-making device for autonomous driving, comprising:
a memory, configured to store computer programs; and
a central processing unit, configured to implement the steps of the hybrid decision-making method for autonomous driving according to claim 1 when executing the computer programs.

10. A computer-readable storage medium, wherein computer programs are stored in the computer-readable storage medium, and cause a central processing unit to implement the steps of the hybrid decision-making method for autonomous driving according to claim 1 when being executed by the central processing unit.
